(19) United States
(12) Patent Application Publication
(10) Pub. No.: US 2002/0017748 A1
(43) Pub. Date: Feb. 14, 2002

(54) Longitudinal adjusting element

(76) Inventors: Armin Sander, Furth (DE); Frank Weisser, Pegnitz (DE); Martin Potrykus, Bamberg (DE); Stefan Richter, Ahorntal (DE); Gerhard Wunderling, Pegnitz (DE)

Correspondence Address: KENYON & KENYON, One Broadway, New York, NY, 10004, US

(21) Appl. No.: 09/782,073

(22) Filed: Feb. 12, 2001

(30) Foreign Application Priority Data
Feb. 10, 2000 (DE) 100 06 061.7
Mar. 10, 2000 (DE) 100 11 693.0

(51) Int. Cl. F16F 5/00

(52) U.S. Cl. 267/64.12; 267/64.11

(57) ABSTRACT

A longitudinal adjusting element has a housing (1) which is filled with a pressurizing medium and in which a piston (12) including a piston rod (16) is guided displaceably. The housing chambers (13,14) which are separated from each other by the piston (12) can be connected with each other or separated from each other with the assistance of a valve device (17). The valve device (17) has at least two overflow ducts (16,40) [sic. (26,40)] which have different throttling effects and which take effect jointly or successively while valve pin (29) is slid in to varying extents.

### BACKGROUND INFORMATION

The present invention relates to a longitudinal adjusting element having a housing in which a piston is displaceably guided which allows housing chambers, which are separate from each other and filled with a pressurizing medium, to be connected with each other and/or to be separated from each other via a valve device.

Such a longitudinal adjusting element which is known, in particular, as a longitudinally adjustable gas spring, is used in practice on a large scale in two basic designs. In one version, a valve device is mounted at the end of a housing facing away from the exit of a piston rod. The connection of two housing chambers, which are separated from each other by a piston, takes place via the valve device and an annular duct formed between an outer tube and an inner tube of the housing.

In the other version, the valve device is mounted inside the piston and actuated via an actuating rod which is arranged and guided inside the piston rod which has a hollow design. The bypass duct of the valve device can be designed as a throttle duct to enable damping of the slide-in or slide-out movements of the piston rod during the opening of the valve.

In these known longitudinally adjustable gas springs, because of the constancy of the throttle coefficients of the valve device, the slide-in and slide-out speeds, respectively, depend primarily on the difference in the forces acting, while the valve device is open, on one hand, upon the piston in the slide-out direction and, on the other hand, upon the piston rod due to the external load in the slide-in direction. Because of this, the slide-in or slide-out speeds of the piston rod can be too high or two low.

### SUMMARY OF THE INVENTION

The object of the present invention is to design a longitudinal adjusting element of the type mentioned at the outset in such a manner that the slide-out speed of the piston rod is influenceable.

This objective is achieved according to the present invention by the features of claim 1. For that purpose, at least two overflow ducts connecting the two housing chambers which are separated by the piston can be opened or closed concurrently or successively as well as individually. In this manner, a change in the throttling of the pressurizing medium, for example, gas and/or hydraulic fluid flowing through the valve device is achieved in steps including corresponding transition regions.

Further developments of the basic principle are specified in claims 2 through 6 whereas claims 7 through 10 reproduce structural developments.

### BRIEF DESCRIPTION OF THE DRAWING

In the following, exemplary embodiments as well as advantages and details of the present invention are explained in greater detail on the basis of a drawing in which

FIG. 1 shows a longitudinally adjustable gas spring in a longitudinal section;

FIG. 2 shows a an enlarged view of a cut-away portion of the gas spring in a longitudinal section with closed valve device;

FIG. 3 shows a representation according to FIG. 2 with partially open valve device;

FIG. 4 shows a representation according to FIG. 2 with the valve device being further opened;

FIG. 5 shows a representation according to FIG. 2 with completely open valve device;

FIG. 6 shows a representation according to FIG. 2 with the valve device being partially closed again;

FIG. 7 shows a diagram depicting the slide-out speed of the piston including the piston rod over the release path of the valve device;

FIG. 8 shows a cut-away portion of the gas spring which features a valve device in the closed condition which is modified with regard to FIGS. 2 through 6;

FIG. 9 shows a representation according to FIG. 8 with partially open valve device;

FIG. 10 shows a representation according to FIG. 8 with completely open valve device.

In all Figures, equivalent parts are provided with the same reference numerals.

### DETAILED DESCRIPTION

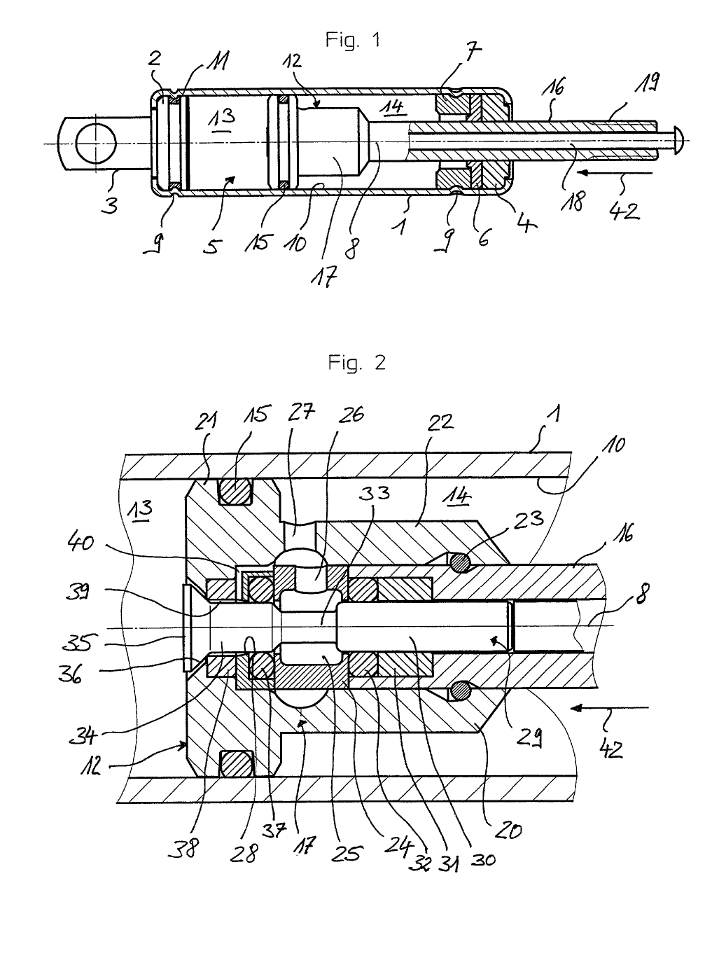

The longitudinal adjusting element shown in FIG. 1 is designed as a gas spring having an essentially cylindrical housing 1 which is closed at one end by a bottom 2 to which a fastening element 3 is attached which is designed as a so-called “eye”. At the other end, housing 1 is closed by an annularly cylindrical guide 4 upon whose face facing interior space 5 of housing 1 is engaged a sealing ring 6. This [sealing ring], in turn, is retained by a retaining ring 7 and braced against guide 4 in the direction of center longitudinal axis 8 of housing 1. Retaining ring 7 and bottom 2 are retained by indentations 9 formed in housing 1. Interior space 5 of housing 1 is sealed in a gas-tight manner toward the outside in the region of inside wall 10 of housing 1 by a seal 11 at bottom 2 and by sealing ring 6 in the region of guide 4.

In interior space 5, a piston 12 is arranged in a manner that it is displaceable in the direction of axis 8, the piston dividing interior space 5 into a first and a second housing chamber 13 and 14, respectively. Piston 12 is sealed with respect to inside wall 10 by a seal 15. A piston rod 16 having a tubular and, therefore, hollow design is attached to piston 12, the piston rod being led outward through retaining ring 7, and sealing ring 6 as well as through guide 4. Sealing ring 6 fits tightly on piston rod 16 so that a gas-tight seal toward the outside is guaranteed in this region, as well.

A valve device 17, which is shown in greater detail in FIGS. 2 through 6, is arranged in piston 12. In piston rod 16, an actuating rod 18 is arranged in a manner that it is displaceable in the direction of axis 8. Valve device 1 can be actuated with the assistance of actuating rod 18 by pressing the actuating rod into piston rod 16. A fastening element 19 formed as a thread is provided on piston rod 16.

In interior space 5, i.e., in housing chambers 13, 14, a compressed gas filling and, possibly, hydraulic fluid are present at least partially. If interior space 5 is at least nearly exclusively filled with compressed gas, then the longitudinal adjusting element is a longitudinally adjustable gas spring which has spring qualities even when valve device 17 is closed. If interior space 5 is filled with hydraulic fluid to a considerable extent and only to a smaller degree with compressed gas, then it is a hydraulically blockable gas spring. In addition to the compressed gas, a small quantity of oil is also present in the interior space 5 for lubrication purposes. If the mentioned hydraulic fluid is present, it constitutes the oil.

Valve device 17 allows housing chambers 13, 14 to be connected with each other and to be separated from each other. While, corresponding to FIG. 2, valve device 17 is closed, these housing chambers 13, 14 are separated form each other. Piston 12 is designed as valve housing 20. In addition to a piston disk 21 which carries seal 15 and is guided on inside wall 10 of housing 1, the piston has a hollow cylindrical extension [attachment element] 22 in which piston rod 16 is secured by a clamping ring 23. Located between piston rod 16 and piston disk 21 is an annular filler 24 in which, concentrically to axis 8, an annular duct 25 is formed which is connected to second housing chamber 14 via a first overflow duct 26 having a small throttle effect and [via] a connecting duct 27 formed in extension 22.

Adjacent to filler 24, piston 12, namely in particular, piston disk 21, is provided with an opening 28 leading to first housing chamber 13. In opening 28, annular duct 25, and the adjacent region of hollow piston rod 16, a valve pin 29 is arranged whose displacement in the direction of axis 8 is carried out by actuating rod 18. Valve pin 29 has a cylindrical guide section 30 which is guided in a guide sleeve 31 in piston rod 16. An O-ring seal 32 is arranged between this guide sleeve 31 and filler 24, in the immediate vicinity of annular duct 25, the O-ring seal engaging against cylindrical guide section 30, forming a gas-tight seal toward the outside.

Adjacent to cylindrical guide section 30, valve pin 29 has a constricted, likewise essentially cylindrical bridging section 33 which is located in annular duct 25 when valve device 17 is closed, corresponding to FIG. 2. Bridging section 33, in turn, is adjoined by a cylindrical section which is cylindrical damping section 34. When valve device 17 is closed, this damping section 34 is located in opening 28. A valve disk 35 widening in a truncated cone shape and having a double function is formed on the end of valve pin 29 facing first housing chamber 13. First of all, this valve disk 35 makes it impossible for valve pin 29 to be forced out toward the outside by piston rod 16 due to the high pressure in interior space 5. Moreover, the conical surface of valve disk 35 serves as a sealing surface 36.

An O-ring seal 37 corresponding to O-ring seal 32 is arranged in opening 28 of piston 12 adjacent to filler 24 and in the immediate vicinity of annular duct 25, the O-ring seal engaging against damping section 34, forming a seal. In the opening, adjacent to valve disk 35, provision is made for a valve disk seal 38 which engages against sealing surface 36 of valve disk 35, forming a seal. A narrow annular duct 39 is formed between this seal 38 and damping section 34.

Connecting duct 27 in extension 22 is connected to opening 28 via a second overflow duct 40 having a large throttle effect. Overflow duct 40 opens into opening 28 between O-ring seal 37 a valve disk seal 38, thus being always connected to annular duct 39. While connecting duct 27 and first overflow duct 26 have comparatively large cross-sections through which gas and/or hydraulic fluid can flow in a comparatively lossless manner, second overflow duct 40 has a relatively narrow cross-section so that the medium flowing therethrough is subject to a relatively strong throttling [effect].

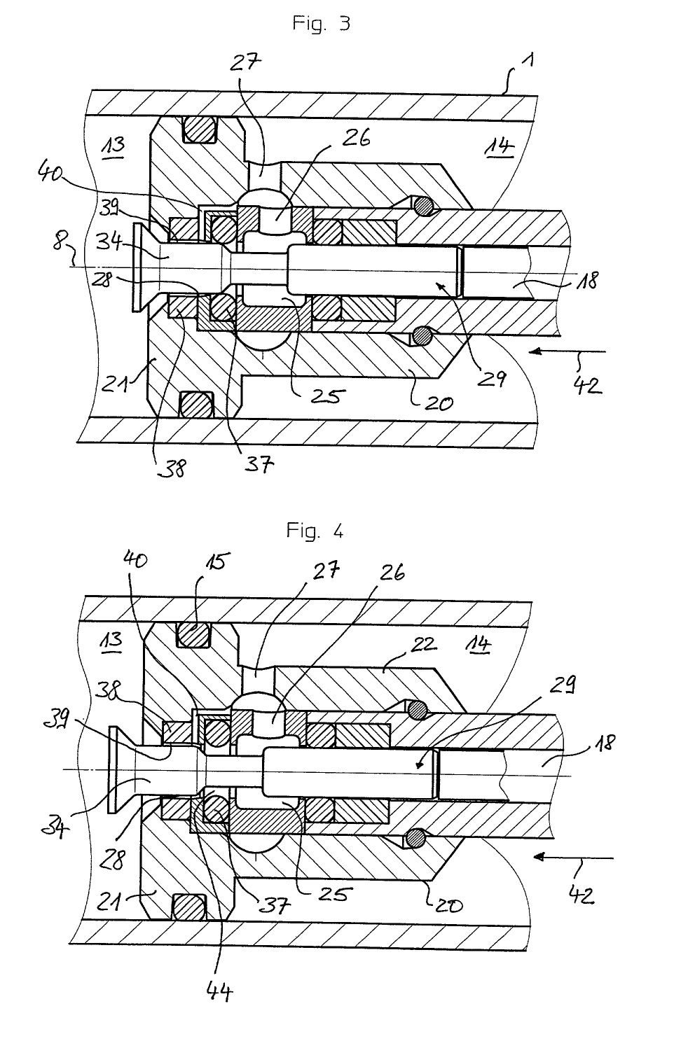

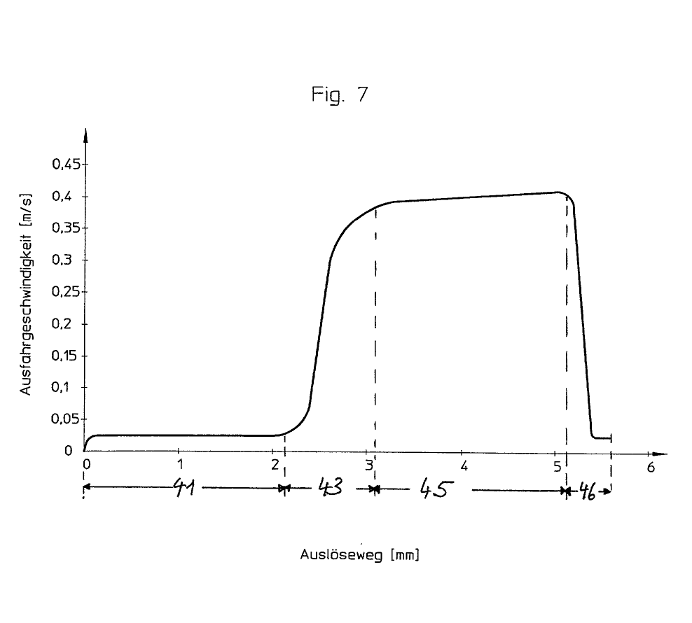

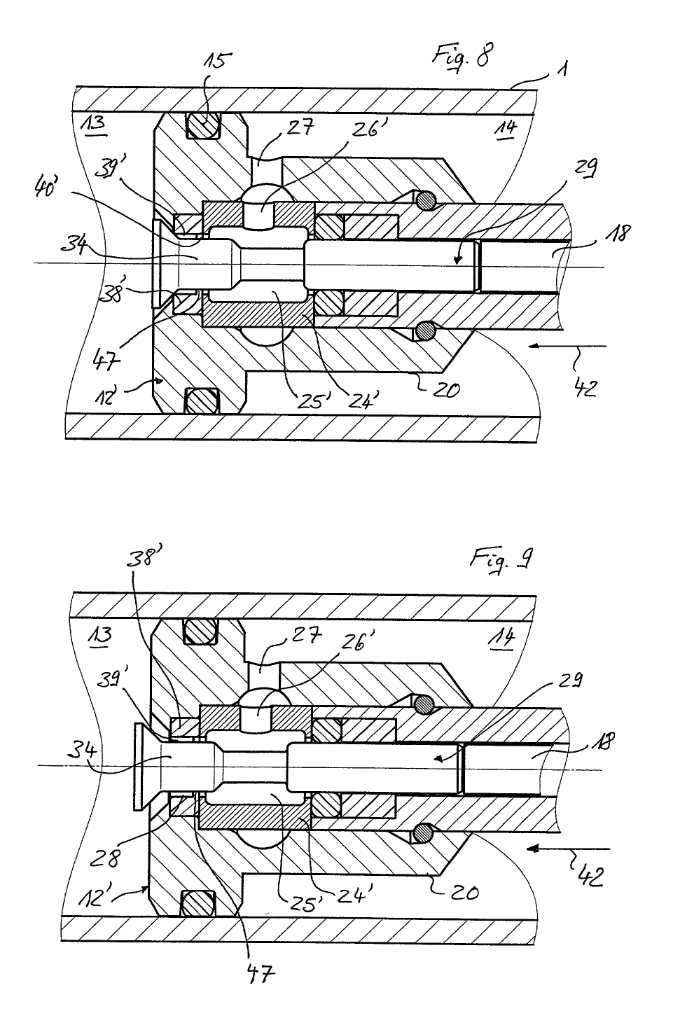

In the following, the mode of functioning is explained on the basis of FIGS. 3 through 6 and in the light of diagram depicted in FIG. 7. FIGS. 3 through 6 show different slide-in positions of valve pin 29 whereas in FIG. 7, the slide-out speed of piston 12, together with piston rod 16, of a gas spring filled with a medium under a given pressure is shown over this slide-in path or release path of valve pin 29. Because of the fluidic interrelationship, the slide-out speed is a measure for the throttling in valve device 17 for the different slide-in positions or release paths of valve pin 29.

In the representation in FIG. 3, valve pin 29 is slid in by a first release path 41 in slide-in direction 42, only valve disk seal 38 being lifted off from sealing surface 36. O-ring seal 37 still engages on damping section 34. Pressurizing medium can flow from second housing chamber 14 to first housing chamber 13 only via connecting duct 27 and second overflow duct 40 as well as annular duct 39, being throttled to a correspondingly high degree. Thus, piston 12, including piston rod 16, slides out slowly over release path 41.

When forcing valve pin 29 further in in slide-in direction 42 by a second release path 43, O-ring seal 37 lifts off from damping section 34, according to the representation in FIG. 4, thus forming a further annular gap 44 wherethrough pressurizing medium can flow into annular duct 39 via connecting duct 27 and first overflow duct 26 as well as through annular duct 25. Damping is markedly reduced as a result of which the slide-out speed of piston 12 is markedly increased. Second release path 43 defines a transition region in the slide-out speed. The slide-out speed of piston 12 steeply increases over release path 43, i.e., the damping strongly decreases since the cross-section of annular gap 44 strongly increases. Because of this, virtually no medium flows via second overflow duct 40 under a corresponding throttling effect any more. A small throttling occurs only in annular duct 39 which is present unchanged.

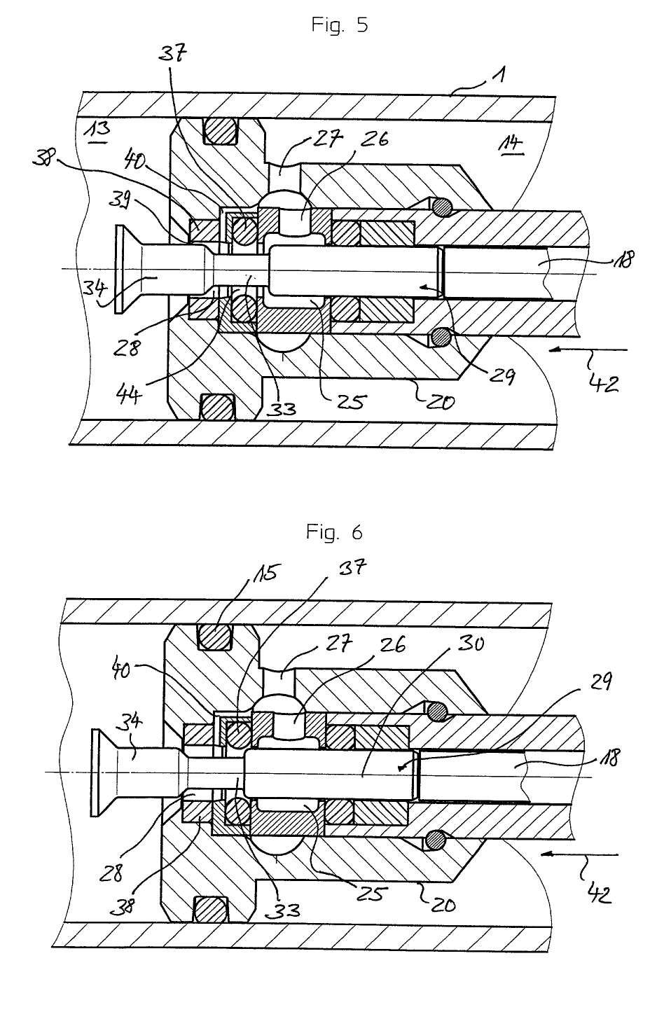

When forcing valve pin 29 further in by a third release path 45 according to FIG. 5, damping section 34 of valve pin 29 comes out of the superposition [overlap] with valve disk seal 38 so that annular duct 39 is continually shortened. Since in this case, such as in the case of the position according to FIG. 4, O-ring seal 37 is in superposition with bridging section 33, the pressurizing medium can flow up to annular duct 39 in a nearly unthrottled manner, the annular duct, in turn, being continuously reduced in its throttle effect which is small anyway.

During maximum possible forcing in of valve pin 29 in slide-in direction 42 by a fourth release path 46, corresponding to the representation in FIG. 6, seal 38 indeed comes completely into superposition with bridging section 33 so that here, virtually no throttling takes place any more. However, O-ring seal 37 makes contact against guide section 30 of valve pin 29 so that first overflow duct 26 is occluded again and pressurizing medium can only flow via strongly throttling second overflow duct 40. During this forcing in over fourth release path 46, the slide-out speed decreases to the same value again which is given over first release path 41. As follows from the above explanation, overflow ducts 26, 40 are arranged and formed functionally parallel to each other and take effect successively.

The embodiment according to FIGS. 8 through 10 differs only slightly from the embodiment according to FIGS. 2 through 6. As far as no new description is given, reference is made to the above description.

The exemplary embodiment according to FIGS. 8 through 10 differs from the exemplary embodiment according to FIGS. 2 through 6 essentially in that second overflow duct 40′ does not branch from connecting duct 27 but opens out from annular duct 25′ of filler 24′. Consequently, second overflow duct 40′ is not connected in parallel with first overflow duct 26′ but in series with it. This does not bring about any considerable difference in terms of functioning since virtually no throttling occurs in first overflow duct 26.

Valve disk seal 38′ has a collar 47 which engages on damping section 34 and includes second overflow duct 40′ which is formed in this collar 47 as a slit. This second overflow duct opens into annular duct 39′ formed between section 34 and seal 38′.

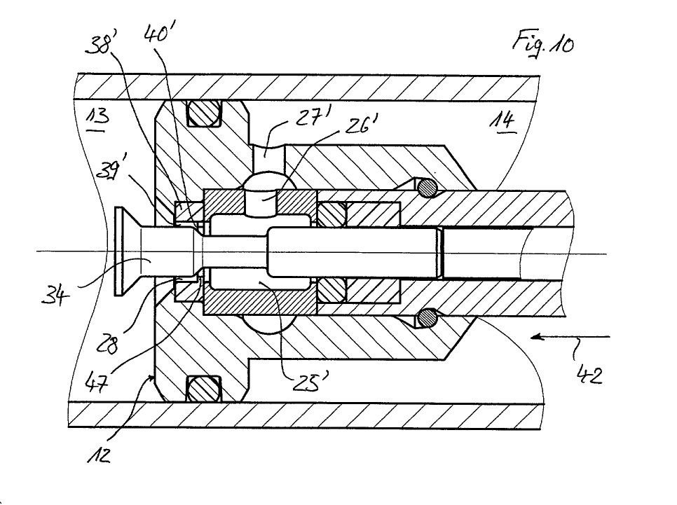

When valve pin 29 is moved in slide-in direction 42 from the closed position of valve device 17′ shown in FIG. 8 to the partially open position shown in FIG. 9, then the whole pressurizing medium flows from second housing chamber 14 to first housing chamber 13 via connecting duct 27, first overflow duct 26′, annular duct 25′, second overflow duct 40′ and annular duct 39′. In the process, the slide-out speed of piston 12′, including piston rod 16, corresponds to that over first release path 41 in FIG. 7. The throttling takes place essentially in second overflow duct 40′.

When valve pin 29 is slid in further in slide-in direction 42 until second overflow duct 40′ gets into superposition with bridging section 33, according to the representation in FIG. 10, then second overflow duct 40′ is substantially out of action. Then, the pressurizing medium can flow from second housing chamber 14 to first housing chamber 13 in an essentially unthrottled manner, this corresponding approximately to the slide-out speed over third release path 45 in FIG. 7. During the displacement of valve pin 29, a transition region appears in this case as well which corresponds to that over second release path 43 in FIG. 7. This transition region having a steep increase in the slide-out speed appears when annular gap 44′ gets constantly larger while valve pin 29 is slid in. In this context, a fourth release path, as is shown in FIG. 7, can be implemented as well.

In both embodiments, a comparable throttling occurs when piston rod 16, including piston 12 or 12′, is slid into housing 1 while valve device 17 or 17′ is partially or completely open and, in the process, the pressurizing medium flows form first housing chamber 13 into second housing chamber 14.

List of Reference Numerals

| | |
|---|---|
| 1 | housing |
| 2 | bottom |
| 3 | fastening element |
| 4 | guide |
| 5 | interior space |
| 6 | sealing ring |
| 7 | retaining ring |
| 8 | center longitudinal axis |
| 9 | indentation |
| 10 | inside wall |
| 11 | seal |
| 12 | piston |
| 13, 14 | housing chamber |
| 15 | seal |
| 16 | piston rod |
| 17 | valve device |
| 18 | actuating rod |
| 19 | fastening element |
| 20 | valve housing |
| 21 | piston disk |
| 22 | extension |
| 23 | clamping ring |
| 24 | filler |
| 25 | annular duct |
| 26 | (first) overflow duct |
| 27 | connecting duct |
| 28 | opening |
| 29 | valve pin |
| 30 | guide section |
| 31 | guide sleeve |
| 33 | bridging section |
| 34 | damping section |
| 35 | valve disk |
| 36 | sealing surface |
| 37 | ring seal |
| 38 | [valve] disk seal |
| 39 | annular duct |
| 40 | (second) overflow duct |
| 41 | first release path |
| 42 | slide-in direction |
| 43 | second release path |
| 44 | annular gap |
| 45 | third release path |
| 46 | fourth release path |
| 47 | collar |

1. A longitudinal adjusting element having a housing (1), in which a piston (12) is displaceably guided which allows housing chambers (13,14), which are separate from each other and filled with a pressurizing medium, to be connected with each other and/or to be separated from each other via a valve device (17), the valve device (17) having at least two overflow ducts (26,40;26,40′) which have different throttling effects and which take effect jointly or successively while a valve pin (29) is slid in to varying extents.

2. The longitudinal adjusting element as recited in claim 1, wherein the overflow ducts (40,26) are arranged parallel to each other and can be successively connected to an opening (28) provided in the piston (12) during the sliding in of the valve pin (29), the valve device (17) which is connected to the one housing chamber (14) via a first overflow duct (26) being connected to the other housing chamber (13) via the opening.

3. The longitudinal adjusting element as recited in claim 1, wherein the overflow ducts (26′,40′) are arranged in series.

4. The longitudinal adjusting element as recited in one of the claims 1 through 3, wherein the overflow ducts (26,40;26′,40′) have different throttling effects.

5. The longitudinal adjusting element as recited in claim 5, wherein the (second) overflow duct (40,40′) which is opened when the valve pin (29) is moved out of a closed position of the valve device (17,17′) over a first release path (41) has a larger throttle effect than the other (first) overflow duct (26,26′).

6. The longitudinal adjusting element as recited in claim 5, wherein, between the first release path (41) and a third release path (45) in which the first overflow duct (26,26′) having a smaller throttle effect is active, the valve pin (29) can be displaced over a second release path (43) over which the throttle effect decreases from a large throttle effect to a small throttle effect.

7. The longitudinal adjusting element as recited in one of the claims 1 through 7 [sic], wherein the valve device (17) has a first seal (38,38′) which sealingly engages on the valve pin (29) only in the closed position of the valve device (17,17′), the (second) overflow duct (40,40′), which has a comparatively large throttle effect, opening into an opening (28) [at a location] upstream of the seal (38,38′) in the slide-in direction (42) of the valve pin (29).

9. [sic] The longitudinal adjusting element as recited in claim 8 [sic], wherein the valve device (17) has a second seal (37) which is arranged upstream of the second overflow duct (40) in the slide-in direction (42) and which, during the displacement of the valve pin (29) clears an annular gap (44) which connects the first overflow duct (26) to the opening (28).

10. [sic] The longitudinal adjusting element as recited in claim 8 or 9 [sic], wherein the valve pin (29) has a cylindrical damping section (34) on which the seal (37) arranged upstream of the second overflow duct (40) engages at least over a part of the release path (41) of the valve pin (29), and upstream of which a constricted bridging section (33) is arranged with which the seal (37) gets into superposition [overlap] during a second and a third release path (43 and 45, respectively).

11. [sic] The longitudinal adjusting element as recited in claim 10 [sic], wherein a cylindrical guide section (30) is arranged upstream of bridging section (33), the seal (37) sealingly engaging on the guide section over a fourth release path (46).

12. [sic] The longitudinal adjusting element as recited in claim 1, wherein the valve pin (29) has a cylindrical damping section (34); a second overflow duct (40) [sic. (40′)] which has a larger throttle effect in comparison with the other overflow duct (26′) being formed between the damping section and a collar-type counterpart (47) both in the closed position of the valve device (17′) and over a first release path (41) of the valve pin (29); a bridging section (33) which is constricted in comparison with the cylindrical damping section (34) being arranged upstream of the damping section; the counterpart (47) getting into superposition with the bridging section during a second and a third release path (43 and 45, respectively) of the valve pin (29).
